(19) United States
(12) Patent Application Publication
(10) Pub. No.: US 2026/0246930 A1
(43) Pub. Date: Aug. 20, 2026

(54) METHOD, APPARATUS, AND MEDIUM FOR VIDEO PROCESSING

(71) Applicant: Beijing Volcano Engine Technology Co., Ltd., Beijing (CN)

(72) Inventors: Yingming FAN, Beijing (CN); Hongbin Liu, Beijing (CN); Li Zhang, Los Angeles, CA (US)

(21) Appl. No.: 19/646,353

(22) Filed: Apr. 13, 2026

Related U.S. Application Data
(63) Continuation of application No. PCT/CN2023/124576, filed on Oct. 13, 2023.

(51) Int. Cl. H04N 19/117; H04N 19/147; H04N 19/17; H04N 19/196; H04N 19/82

(52) U.S. Cl. CPC H04N 19/117; H04N 19/147; H04N 19/17; H04N 19/196; H04N 19/82

(57) ABSTRACT

Embodiments of the present disclosure provide a solution for video processing. A method for video processing is proposed. The method comprises: obtaining, for a conversion between a current region of a video and a bitstream of the video, values of a set of sample adaptive offset (SAO) parameters for each of a plurality of video units in the current region by applying a first SAO process on reconstructed samples of the current region; applying a second SAO process on the reconstructed samples of the current region based on the values of the set of SAO parameters; and performing the conversion based on a result of the applying of the second SAO process.

### CROSS REFERENCE TO RELATED APPLICATIONS

This application is a continuation of International Application No. PCT/CN2023/124576, filed on Oct. 13, 2023. The entire contents of this application are hereby incorporated by reference in its entirety.

### FIELDS

Embodiments of the present disclosure relates generally to video processing techniques, and more particularly, to multi-pass sample adaptive offset.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality of video coding techniques is generally expected to be further improved.

### SUMMARY

Embodiments of the present disclosure provide a solution for video processing.

In a first aspect, a method for video processing is proposed. The method comprises: obtaining, for a conversion between a current region of a video and a bitstream of the video, values of a set of sample adaptive offset (SAO) parameters for each of a plurality of video units in the current region by applying a first SAO process on reconstructed samples of the current region; applying a second SAO process on the reconstructed samples of the current region based on the values of the set of SAO parameters; and performing the conversion based on a result of the applying of the second SAO process.

According to the method in accordance with the first aspect of the present disclosure, more than one pass of SAO process is applied on a video region. Compared with the conventional solution, where only a single pass of SAO process is applied, the proposed method can advantageously find global optimal SAO parameters for the video region. Thereby, the coding quality can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: obtaining values of a set of sample adaptive offset (SAO) parameters for each of a plurality of video units in the current region by applying a first SAO process on reconstructed samples of a current region of the video; applying a second SAO process on the reconstructed samples of the current region based on the values of the set of SAO parameters; and generating the bitstream based on a result of the applying of the second SAO process.

In a fifth aspect, a method for storing a bitstream of a video is proposed. The method comprises: obtaining values of a set of sample adaptive offset (SAO) parameters for each of a plurality of video units in the current region by applying a first SAO process on reconstructed samples of a current region of the video; applying a second SAO process on the reconstructed samples of the current region based on the values of the set of SAO parameters; generating the bitstream based on a result of the applying of the second SAO process; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates four one-dimensional 3-pixel patterns for the pixel classification in edge offset (EO);

FIG. 5 illustrates an example of band offset (BO);

FIG. 6 illustrates an example of merge groups;

FIG. 7 illustrates a flowchart of a method for video processing in accordance with embodiments of the present disclosure; and

FIG. 8 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

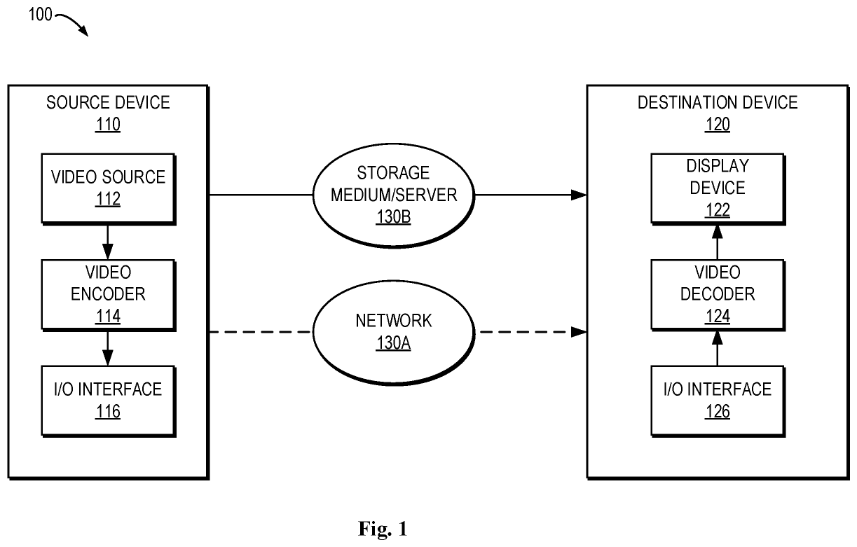

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

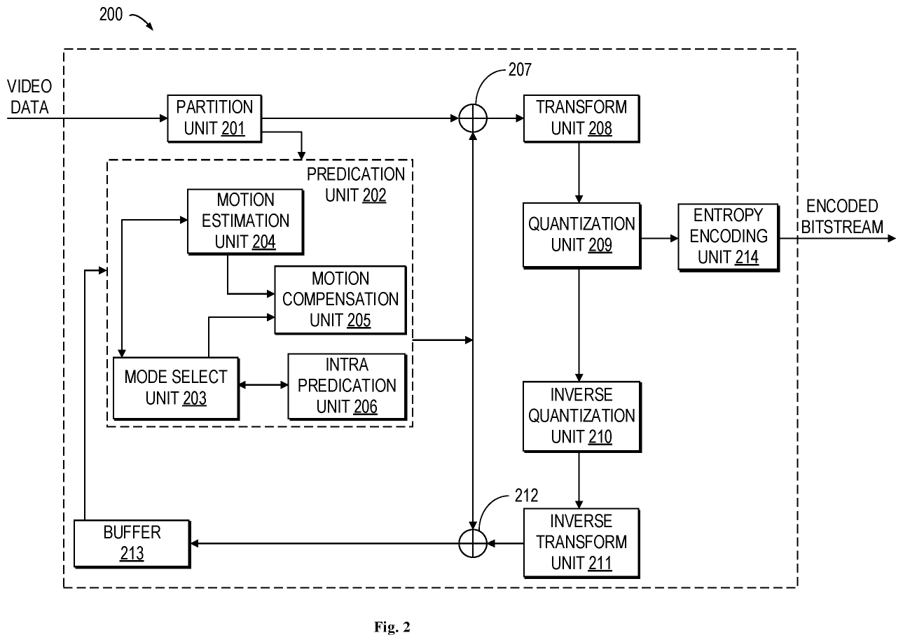

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

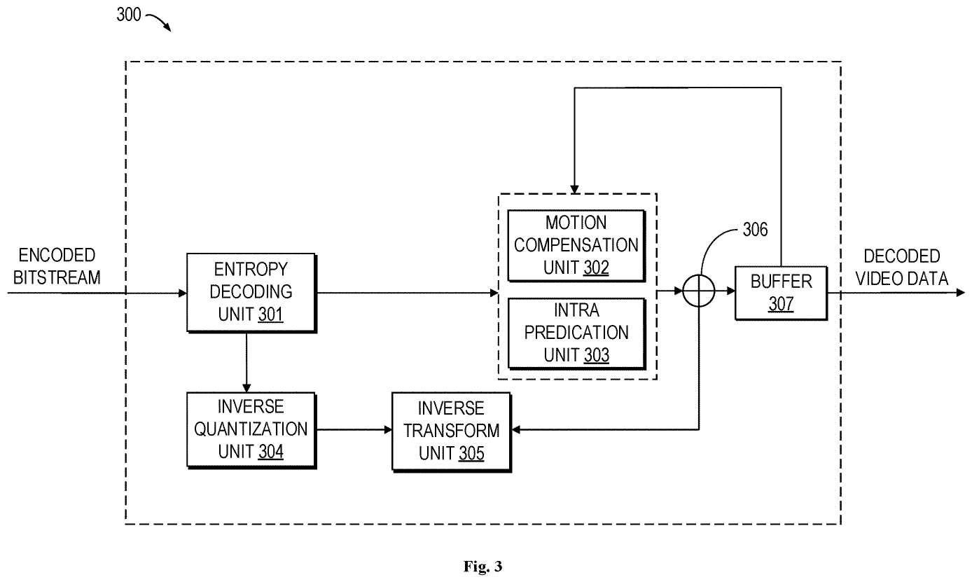

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to image/video coding technologies. Specifically, it is related to sample adaptive offset in image/video coding. It may be applied to the existing image/video coding standard like HEVC, or the Versatile Video Coding. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1. Sample Adaptive Offset

Sample adaptive offset (SAO) is applied to the reconstructed signal after the deblocking filter by using offsets specified for each coding tree block (CTB) by the encoder. The HM and VTM encoders first make the decision on whether or not the SAO process is to be applied for current slice. If SAO is applied for the slice, each CTB is classified as one of five SAO types as shown in Table 1, i.e., SAO type 1~5. The concept of SAO is to classify pixels into categories and reduces the distortion by adding an offset to pixels of each category. SAO operation includes Edge Offset (EO) which uses edge properties for pixel classification in SAO type 1-4 and Band Offset (BO) which uses pixel intensity for pixel classification in SAO type 5. Each applicable CTB has SAO parameters including sao_merge_left_flag, sao_merge_up_flag, SAO type and four offsets. If sao_merge_left_flag is equal to 1, the current CTB will reuse the SAO type and offsets of the CTB to the left. If sao_merge_up_flag is equal to 1, the current CTB will reuse SAO type and offsets of the CTB above. Therefore, there is no need to further signal the SAO type and offsets for the current CTB whenever either sao_merge_left_flag or sao_merge_up_flag is true.

TABLE 1
Specification of SAO type

| | | Number of |
|---|---|---|
| SAO type | sample adaptive offset type to be used | categories |
| 0 | None | 0 |
| 1 | 1-D 0-degree pattern edge offset | 4 |
| 2 | 1-D 90-degree pattern edge offset | 4 |
| 3 | 1-D 135-degree pattern edge offset | 4 |
| 4 | 1-D 45-degree pattern edge offset | 4 |
| 5 | band offset | 4 |

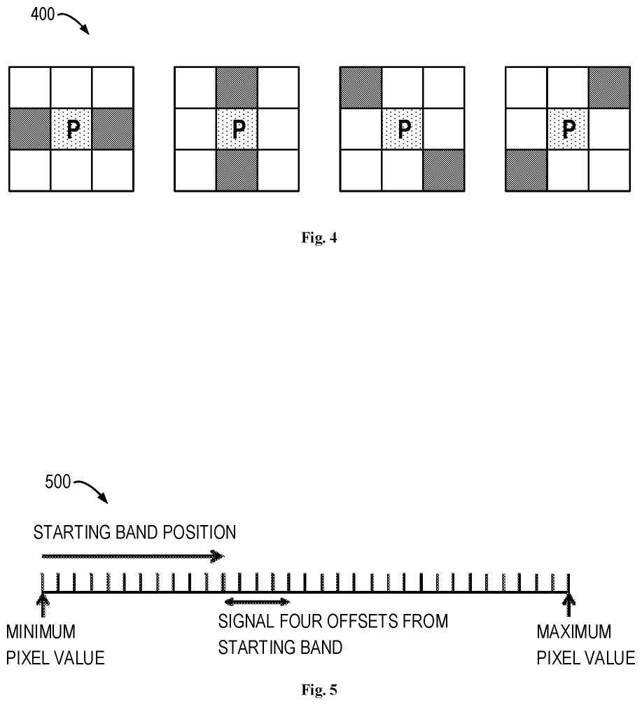

Edge offset uses four 1-D 3-pixel patterns for classification of the current pixel p by consideration of edge directional information, as shown in FIG. 4. FIG. 4 is a schematic diagram 400 illustrating four 1-D 3-pixel patterns for the pixel classification in EO. From left to right these are: 0-degree, 90-degree, 135-degree and 45-degree.

Each CTB is classified into one of five categories according to Table 2.

TABLE 2
Pixel classification rule for EO

| Category | Condition | Meaning |
|---|---|---|
| 0 | None of the below | Largely monotonic |
| 1 | p < 2 neighbours | Local minimum |
| 2 | p < 1 neighbour && p == 1 neighbour | Edge |
| 3 | p > 1 neighbour && p == 1 neighbour | Edge |
| 4 | p > 2 neighbours | Local maximum |

Band offset (BO) classifies all pixels in one CTB region into 32 uniform bands by using the five most significant bits of the pixel value as the band index. In other words, the pixel intensity range is divided into 32 equal segments from zero to the maximum intensity value (e.g. 255 for 8-bit pixels). Four adjacent bands are grouped together and each group is indicated by its most left-hand position as shown in FIG. 5, which is a schematic diagram 500 illustrating an example of band offset (BO). The encoder searches all position to get the group with the maximum distortion reduction by compensating offset of each band.

### 3. Problems

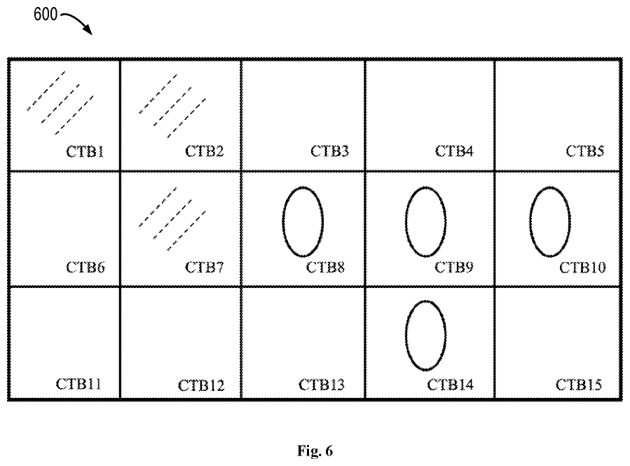

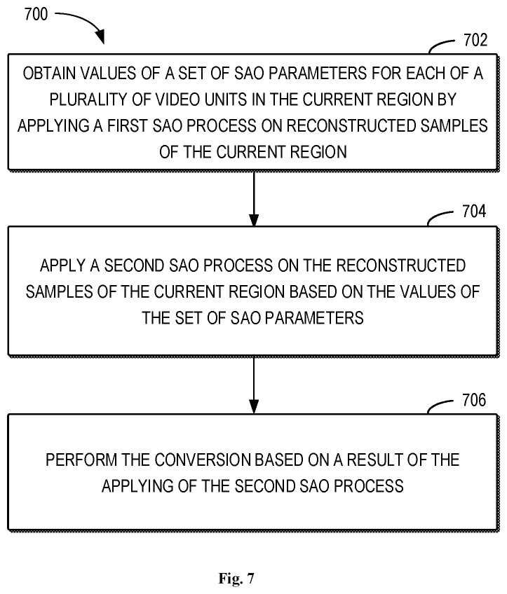

FIG. 6 is a schematic diagram 600 illustrating an example of merge groups. As seen in FIG. 6, Dash line marked CTBs represent a merge group and circle marked CTBs represent another merge group, CTBs without mask are independent CTBs which means derive SAO parameters independently. CTB1 derive SAO parameters for itself, CTB2 use sao_merge_left_flag to inherit SAO parameters from CTB1 and CTB7 use sao_merge_up_flag to inherit SAO parameters from CTB2. A couple of CTBs may be merged into one group and share the same set of SAO parameters. However, only the first CTB (in encoding order) of the group is used to derive the SAO parameters, and the SAO parameters may be suboptimal for the group.

### 4. Detailed Solutions

Improvements for the SAO are proposed to address the above-mentioned problems.

The detailed solutions below should be considered as examples to explain general concepts. These solutions should not be interpreted in a narrow way. Furthermore, these solutions can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

In the following description, “merge group” is used to represent video units which share the same set of parameters (e.g., filtering parameters) that are utilized to reconstruct one video unit. The term “SAO parameters” may represent the SAO on/off flags, and/or SAO types and/or offsets.

For example, in the SAO process, the merge group represents a group of video units (e.g., CTUs/CTBs) that utilize same SAO parameters. More specifically, for a first video unit (e.g., CTU/CTB) in the merge group, the SAO parameters may be signalled while for the remaining CTBs in the merge group, the sao_merge_left_flag or sao_merge_up_flag is set to 1. A “merge group” may include one video unit (e.g., CTU/CTB) or more than one video units (e.g., CTUs/CTBs).
1. It is proposed that derivation of the SAO related parameters may be performed for more than one passes, and the SAO related parameters in the (i+1)th pass may be modified compared with that in the ith pass, i>=0.
   a. In one example, SAO parameters (e.g., SAO type or/and SAO offsets) of a merge group may be modified.
   b. In one example, SAO type of a video unit (e.g., CTU/CTB) may be modified.
   c. In one example, a first merge group and a second merge group in the ith pass may be merged into one group in the (i+1)th pass.
   d. In one example, a video unit (e.g., CTU/CTB) may be classified into a different group in the (i+1)th pass from that of the ith pass.
   e. In one example, SAO on/off flag of a coding unit (e.g., a slice, a tile, a picture, a CTB row etc.) may be modified.
2. It is proposed that more than one video units (e.g., CTUs/CTBs) within a merge group may be used to derive the SAO related parameters of the merge group.
   a. In one example, the more than one video units (e.g., CTUs/CTBs) may be used to derive the SAO type or/and SAO offsets of a luma component.
   b. In one example, the more than one video units (e.g., CTUs/CTBs) may be used to derive the SAO type or/and SAO offsets of a chroma component.
   c. In one example, the more than one video units (e.g., CTUs/CTBs) may include all video units (e.g., CTUs/CTBs) of the merge group.
   d. For example, CTB1, CTB2 and CTB7 in FIG. 6 are within a same merge group. SAO parameters of the merge group may be derived using CTB1, CTB2 and CTB7, instead of only using CTB1.
3. It is proposed that a cost function may be used to decide whether the SAO parameters should be changed in the proposed multi-pass SAO process.
   a. In one example, the cost function may depend on the distortion (denoted by D) reduced by the SAO process or/and the rate (denoted by R) spent on the SAO parameters (e.g., including video unit (e.g., CTU/CTB) level on/off flag, sao_merge_left_flag/sao_merge_up_flag flag, SAO type, SAO offsets etc.).
   b. In one example, a parameter, denoted as lambda, may be further used in the cost function, for example, −D+lambda*R may be used to measure the impact of SAO.
   c. In one example, SAO parameters of a merge group may be updated only when such update parameters could reduce the cost of the merge group.
   d. In one example, a first group may be merged to a second group only when the merging can reduce the cost of the involved merge groups.
   e. In one example, SAO on/off flag of a video unit (e.g., a slice, a tile, a picture, a CTB row etc.) may be modified only when cost of the group including the video unit can be reduced.
   f. In one example, SAO type of a video unit (e.g., a slice, a tile, a picture, a CTB row etc.) may be modified only when cost of the group including the video unit can be reduced.
4. Early termination of multiple-passes may be enabled wherein for one region (e.g., a slice) N passes may be applied while for another region, M passes may be applied, and N is unequal to M.
   a. It is proposed that the multi-pass SAO processes may be terminated when one or more than one of the following conditions are fulfilled.
      i. In one example, the condition may be that the SAO process is performed by more than N passes.
      ii. In one example, the condition may be that the cost of the SAO process is not reduced anymore.
      iii. In one example, the condition may be that the cost of the SAO process is increased after a SAO process.
5. It is proposed that different operations may be performed in different SAO passes.
   a. In one example, in a SAO pass, SAO parameters may be updated for a merge group.
   b. In one example, in a SAO pass, an isolated merge group (a merge group is called isolated merge group when it only contains one video unit (e.g., CTU/CTB)) may be merged to one of its neighboring groups.
   c. In one example, in a SAO pass, two neighboring merge groups may be merged into one group.
   d. In one example, in a SAO pass, two neighboring merge groups may be merged into one group recursively.
   e. In one example, in a SAO pass, SAO on/off flag of a video unit (e.g., CTU/CTB) may be updated.
   f. In one example, in a SAO pass, SAO type of a video unit (e.g., CTU/CTB) may be changed.
   g. In one example, in a SAO pass, merge flag of a video unit (e.g., CTU/CTB) may be changed.
   h. Alternatively, in addition, more than one above operation may be allowed in one SAO pass.
6. Slice/picture/tile/video unit (e.g., CTU/CTB) row/region level SAO on/off decision may be performed after the proposed multi-pass SAO.
   a. Alternatively, such decision may be performed in one or more SAO passes.
   b. In one example, the SAO may be disabled when the proposed multi-pass SAO cannot reduce the cost (e.g., defined in bullet 4).
   c. In one example, the SAO may be disabled when the cost cannot be reduced in a SAO pass.
   d. For example, when the slice level SAO determined and cost of slice level SAO larger than zero, disable slice level SAO flag will better on coding gain.
   e. This step should be executed after all video unit (e.g., CTU/CTB)'s decision inside a slice complete. While for the video unit (e.g., CTU/CTB)'s CABAC writing after video unit (e.g., CTU/CTB) RDO, SAO flag could be set to disable temporarily.
7. The proposed multi-pass SAO may be performed for a slice, a picture, a tile, a video unit (e.g., CTU/CTB) row or a region (e.g., a Region-of-Interest).
   a. In one example, the region may consist of one or more video units (e.g., CTUs/CTBs).
   b. In one example, the region may consist of one or more video unit (e.g., CTU/CTB) rows.
   c. In one example, the region may consist of one or more neighboring video units (e.g., CTUs/CTBs).
   d. Whether the proposed multi-pass SAO is performed may depend on the temporal level/slice type/POC etc.
   e. Whether the proposed multi-pass SAO is performed at a slice, a picture, a tile, a video unit (e.g., CTU/CTB) row or a region level, may depend on the temporal level/slice type/POC etc.
8. The proposed methods may be applied to determine partial set of filter parameters or certain regions, and additional steps may be applied to determine remaining filter parameters.
   a. In one example, for a Region-of-Interest, the multiple pass method may be applied while for the remaining regions within a slice/picture, the single pass method may be applied.
9. The disclosed methods may be applied to other filtering processes, e.g., bilateral filtering, adaptive loop filter (ALF), DCT-domain filtering to determine shared filtering parameters among a merge group.

More details of the embodiments of the present disclosure will be described below which are related to multi-pass sample adaptive offset. The embodiments of the present disclosure should be considered as examples to explain the general concepts and should not be interpreted in a narrow way. Furthermore, these embodiments can be applied individually or combined in any manner.

As used herein, the term “video unit” may represent a color component, a sub-picture, a picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A video unit may be rectangular or non-rectangular.

FIG. 7 illustrates a flowchart of a method 700 for video processing in accordance with some embodiments of the present disclosure. The method 700 may be implemented during a conversion between a current region of a video and a bitstream of the video. As shown in FIG. 7, the method 700 starts at 702 where values of a set of sample adaptive offset (SAO) parameters for each of a plurality of video units in the current region are obtained by applying a first SAO process on reconstructed samples of the current region.

By way of example rather than limitation, the set of SAO parameters may comprise a first indication (e.g., SAO on/off flag) indicating whether SAO is enabled or not, an SAO type, an SAO offset. In some embodiments, the set of SAO parameters may further comprise a second indication (e.g., a syntax element sao_merge_left_flag) indicating whether at least one syntax elements related to the SAO is derived from the corresponding syntax element of the left video unit, and/or a third indication (e.g., a syntax element sao_merge_up_flag) indicating whether at least one syntax elements related to the SAO is derived from the corresponding syntax element of the above video unit. It should be understood that the above examples are described merely for purpose of description. The scope of the present disclosure is not limited in this respect.

As described above with reference to FIG. 6, during the first SAO process, the plurality of video units in the current region may be divided into different merge groups. All video units comprised in a merge group share the same values of the set of SAO parameters. It should be understood that a merge group may comprise one or more video units. In case that the merge group comprises only one video unit, it may also be referred to as an isolated merge group.

At 704, a second SAO process is applied on the reconstructed samples of the current region based on the values of the set of SAO parameters. During the second SAO process, the values of the set of SAO parameters determined in the first SAO process may or may not be updated, i.e., modified. This will be described in detail below. It is seen that at least two passes of SAO process are performed in the proposed solution, thus the proposed solution may also be referred to a multi-pass SAO procedure or the like.

At 706, the conversion is performed based on a result of the applying of the second SAO process. In one example, a third SAO process may be applied on the reconstructed samples of the current region based on the result of the applying of the second SAO process. In another example, the multi-pass SAO procedure may be terminated after the second SAO process.

In some embodiments, the conversion may include encoding the current region into the bitstream. Alternatively or additionally, the conversion may include decoding the current region from the bitstream. It should be understood that the above illustrations are described merely for purpose of description. The scope of the present disclosure is not limited in this respect.

In view of the above, more than one pass of SAO process is applied on a video region. Compared with the conventional solution, where only a single pass of SAO process is applied, the proposed method can advantageously find global optimal SAO parameters for the video region. Thereby, the coding quality can be improved.

In some embodiments, a value of at least one SAO parameter (e.g., the SAO type, the SAO offset, the SAO on/off flag and/or the like) in the set of SAO parameters for one of the plurality of video units may be modified during the second SAO process.

In some embodiments, the plurality of video units may comprise a first group of video units sharing the same values of the set of SAO parameters, and values of the set of SAO parameters for the first group of video units may be modified during the second SAO process. Alternatively or additionally, the plurality of video units may comprise a second group of video units sharing the same values of the set of SAO parameters and a third group of video units sharing the same values of the set of SAO parameters, the second group of video units and the third group of video units may be merged into a single group during the second SAO process. For example, a first merge group and a second merge group in the first pass may be merged into one group in the second pass.

In some embodiments, a first video unit in the plurality of video units may be comprised in a fourth group of video units sharing the same values of the set of SAO parameters during the first SAO process, and the first video unit may be comprised in a fifth group of video units sharing the same values of the set of SAO parameters during the second SAO process, and the fifth group may be different from the fourth group. For example, a video unit may be classified into a different group in the second pass from that of the first pass.

In some embodiments, the plurality of video units may comprise a sixth group of video units sharing the same values of the set of SAO parameters. Moreover, values of the set of SAO parameters for the sixth group of video units may be determined based on more than one video units in the sixth group of video units during the second SAO process. Compared with the conventional solution where only the first video unit of a merge group is used to derive the SAO parameters, the SAO parameters may be refined by considering more than one video unit. Thereby, the coding quality can be improved.

In some additional or alternative embodiments, the set of SAO parameters may comprise an SAO type of a luma component, an SAO offset of a luma component, an SAO type of a chroma component, and/or an SAO offset of a chroma component. For example, more than one video unit (e.g., CTUs/CTBs) may be used to derive the SAO type or/and SAO offsets of a luma component. In addition or alternatively, more than one video unit (e.g., CTUs/CTBs) may be used to derive the SAO type or/and SAO offsets of a chroma component. In some embodiments, the more than one video units comprise all video units in the sixth group of video units. By way of example, with reference to FIG. 6, CTB1, CTB2 and CTB7 are within a same merge group. The set of SAO parameters for the merge group may be derived by using all of CTB1, CTB2 and CTB7, instead of only using CTB1.

In some embodiments, whether to modify the values of the set of SAO parameters during the second SAO process may be determined based on a cost function associated with the set of SAO parameters. For example, the cost function may be dependent on a distortion reduced by an SAO process with values of set of SAO parameters and/or a rate for coding values of the set of SAO parameters. By way of example rather than limitation, the cost function may be: C=−D+lambda×R, where C represents a cost, D represents the distortion, R represents the rate, and lambda represents a predetermined parameter. It should be understood that the above illustrations and/or examples are described merely for purpose of description. The scope of the present disclosure is not limited in this respect.

In some embodiments, the plurality of video units may comprise a seventh group of video units sharing the same values of the set of SAO parameters. Moreover, a first cost may be determined for the values of the SAO parameters for the seventh group of video units based on the cost function.

In addition, at 704, further values of the set of SAO parameters for the seventh group of video units may be obtained by applying an SAO process on reconstructed samples of the seventh group of video units. Then, a second cost may be determined for the further values based on the cost function. In accordance with a determination that the second cost is smaller than the first cost, the values of the set of SAO parameters may be updated with the further values. Otherwise, the values of the set of SAO parameters may not be updated.

By way of example rather than limitation, SAO parameters of a merge group may be updated only when such update parameters could reduce the cost of the merge group. In a further example, SAO on/off flag of a video unit (e.g., a slice, a tile, a picture, a CTB row etc.) may be modified only when cost of the group including the video unit can be reduced. In a still further example, SAO type of a video unit may be modified only when cost of the group including the video unit can be reduced. It should be understood that the above illustrations are described merely for purpose of description. The scope of the present disclosure is not limited in this respect.

In some embodiments, the plurality of video units may further comprise an eighth group of video units sharing the same values of the set of SAO parameters. A second cost may be determined for the values of the SAO parameters for the eighth group of video units based on the cost function. Moreover, at 704, a single group of video units may be obtained by merging the seventh group of video units and the eighth group of video units. Further values of the set of SAO parameters for the single group of video units may be obtained by applying an SAO process on reconstructed samples of the single group of video units, and a third cost for the further values may be determined based on the cost function. In accordance with a determination that the third cost is smaller than the first cost and the second cost, the values of the set of SAO parameters for the seventh group of video units and the eighth group of video units may be updated with the further values. By way of example rather than limitation, a first merge group may be merged to a second merge group only when the merging can reduce the cost of the involved merge groups.

In some embodiments, early termination of the multi-pass SAO procedure may be enabled. For example, the number of SAO processes applied for the current region may be different from the number of SAO processes applied for a further region of the video different from the current region.

In some embodiments, the multi-pass SAO procedure comprising the first SAO process and the second SAO process may be terminated if at least one of the following conditions is met: the number of SAO processes applied for the current region is larger than a threshold, a cost of an SAO process is not reduced, or the cost of the SAO process is increased. It should be understood that the above examples of termination conditions are described merely for purpose of description. The scope of the present disclosure is not limited in this respect.

In some embodiments, the plurality of video units may comprise a group of video units sharing the same values of the set of SAO parameters, and the values of the set of SAO parameters for the group of video units may be updated during the second SAO process. Additionally or alternatively, a video unit neighboring to the group of video units may be merged into the group of video units during the second SAO process. In some further embodiments, a further group of video units neighboring to the group of video units may be merged into the group of video units during the second SAO process. Alternatively, video units in the further group of video units neighboring to the group of video units may be merged into the group of video units recursively during the second SAO process.

In some additional or alternative embodiments, the above-mentioned first indication (e.g., SAO on/off flag) of a video unit in the plurality of video units may be updated during the second SAO process. Additionally or alternatively, an SAO type of a video unit in the plurality of video units may be updated during the second SAO process. Furthermore, a merge flag of a video unit in the plurality of video units may be updated during the second SAO process.

In some embodiments, information regarding whether to enable the SAO at one of the following levels may be determined after the multi-pass SAO procedure comprising the first SAO process and the second SAO process is performed: a slice level, a picture level, a tile level, a coding tree unit (CTU) level, a coding tree block (CTB) level, or a region level. Alternatively, the information regarding whether to enable the SAO at one of the following levels may be determined during a multi-pass SAO procedure comprising the first SAO process and the second SAO process: a slice level, a picture level, a tile level, a coding tree unit (CTU) level, a coding tree block (CTB) level, or a region level.

By way of example, the SAO may be disabled if the multi-pass SAO procedure does not reduce a cost associated with the set of SAO parameters. The cost may be determined based on the above-mentioned cost function. In another example, the SAO may be disabled if a cost associated with the set of SAO parameters is not reduced in an SAO process of the multi-pass SAO procedure. In a further example, if a cost of slice level SAO is larger than zero, the slice level SAO may be disabled. In a still further example, an SAO flag for a video unit of the plurality of video units may be set to disable temporarily for a context-based adaptive binary arithmetic coding (CABAC) writing of the video unit.

In some embodiments, the current region may comprise one of the following: a slice, a picture, a tile, a CTU row, a CTB row, or a region of interest. By way of example, the region of interest may comprise at least one CTU or at least one CTB, at least one CTU row or at least one CTB row, at least one neighboring CTU or at least one neighboring CTB, or the like. It should be understood that the above illustrations are described merely for purpose of description. The scope of the present disclosure is not limited in this respect.

In some embodiments, information regarding whether the multi-pass SAO procedure is performed for a further region of the video may be dependent on a temporal level, a slice type, a picture order count (POC), and/or the like.

In some embodiments, information regarding whether a multi-pass SAO procedure is performed at one of the following levels may be dependent on a temporal level, a slice type, or a POC: a slice level, a picture level, a tile level, a CTU level, a CTB level, or a region level.

In some embodiments, the set of SAO parameters may be a part of all SAO parameters for a video unit of the plurality of video units. By way of example, the rest of the all SAO parameters may be determined based on the single-pass SAO procedure.

In some embodiments, the multi-pass SAO procedure comprising the first SAO process and the second SAO process may be applied to a part of regions in a slice or a picture of the video. By way of example rather than limitation, the part of regions may comprise a region of interest. In addition, a single-pass SAO procedure may be applied to the rest of regions in the slice or the picture.

In some embodiments, the proposed method may also be applied to a filtering process different from the SAO, such as, a bilateral filtering, an adaptive loop filter (ALF), or a discrete cosine transform (DCT) domain filtering, or the like. It should be understood that the above examples are described merely for purpose of description. The scope of the present disclosure is not limited in this respect.

According to further embodiments of the present disclosure, a non-transitory computer-readable recording medium is provided. The non-transitory computer-readable recording medium stores a bitstream of a video which is generated by a method performed by an apparatus for video processing. In the method, values of a set of sample adaptive offset (SAO) parameters for each of a plurality of video units in the current region are obtained by applying a first SAO process on reconstructed samples of a current region of the video. A second SAO process is applied on the reconstructed samples of the current region based on the values of the set of SAO parameters. Moreover, the bitstream is generated based on a result of the applying of the second SAO process.

According to still further embodiments of the present disclosure, a method for storing bitstream of a video is provided. In the method, values of a set of sample adaptive offset (SAO) parameters for each of a plurality of video units in the current region are obtained by applying a first SAO process on reconstructed samples of a current region of the video. A second SAO process is applied on the reconstructed samples of the current region based on the values of the set of SAO parameters. Moreover, the bitstream is generated based on a result of the applying of the second SAO process, and stored in a non-transitory computer-readable recording medium.

Implementations of the present disclosure can be described in view of the following clauses, the features of which can be combined in any reasonable manner.

Clause 1. A method for video processing, comprising: obtaining, for a conversion between a current region of a video and a bitstream of the video, values of a set of sample adaptive offset (SAO) parameters for each of a plurality of video units in the current region by applying a first SAO process on reconstructed samples of the current region; applying a second SAO process on the reconstructed samples of the current region based on the values of the set of SAO parameters; and performing the conversion based on a result of the applying of the second SAO process.

Clause 2. The method of clause 1, wherein the set of SAO parameters comprises at least one of the following: a first indication indicating whether SAO is enabled or not, an SAO type, or an SAO offset.

Clause 3. The method of any of clauses 1-2, wherein a value of at least one SAO parameter in the set of SAO parameters for one of the plurality of video units is modified during the second SAO process.

Clause 4. The method of any of clauses 1-3, wherein the plurality of video units comprises a first group of video units sharing the same values of the set of SAO parameters, and values of the set of SAO parameters for the first group of video units are modified during the second SAO process.

Clause 5. The method of any of clauses 1-4, wherein the plurality of video units comprises a second group of video units sharing the same values of the set of SAO parameters and a third group of video units sharing the same values of the set of SAO parameters, the second group of video units and the third group of video units are merged into a single group during the second SAO process.

Clause 6. The method of any of clauses 1-5, wherein a first video unit in the plurality of video units is comprised in a fourth group of video units sharing the same values of the set of SAO parameters during the first SAO process, and the first video unit is comprised in a fifth group of video units sharing the same values of the set of SAO parameters during the second SAO process, and the fifth group is different from the fourth group.

Clause 7. The method of any of clauses 1-6, wherein the plurality of video units comprises a sixth group of video units sharing the same values of the set of SAO parameters, and values of the set of SAO parameters for the sixth group of video units are determined based on more than one video units in the sixth group of video units during the second SAO process.

Clause 8. The method of clause 7, wherein the set of SAO parameters comprises at least one of: an SAO type of a luma component, an SAO offset of a luma component, an SAO type of a chroma component, or an SAO offset of a chroma component.

Clause 9. The method of any of clauses 7-8, wherein the more than one video units comprise all video units in the sixth group of video units.

Clause 10. The method of any of clauses 1-9, wherein whether to modify the values of the set of SAO parameters during the second SAO process is determined based on a cost function associated with the set of SAO parameters.

Clause 11. The method of clause 10, wherein the cost function is dependent on at least one of the following: a distortion reduced by an SAO process with values of set of SAO parameters, or a rate for coding values of the set of SAO parameters.

Clause 12. The method of clause 11, wherein the cost function is: C=−D+lambda×R where C represents a cost, D represents the distortion, R represents the rate, and lambda represents a predetermined parameter.

Clause 13. The method of any of clauses 10-12, wherein the plurality of video units comprises a seventh group of video units sharing the same values of the set of SAO parameters, and a first cost is determined for the values of the SAO parameters for the seventh group of video units based on the cost function.

Clause 14. The method of clause 13, wherein applying the second SAO process comprises: obtaining further values of the set of SAO parameters for the seventh group of video units by applying an SAO process on reconstructed samples of the seventh group of video units; determining a second cost for the further values based on the cost function; and in accordance with a determination that the second cost is smaller than the first cost, updating the values of the set of SAO parameters with the further values.

Clause 15. The method of clause 13, wherein the plurality of video units comprises an eighth group of video units sharing the same values of the set of SAO parameters, a second cost is determined for the values of the SAO parameters for the eighth group of video units based on the cost function, and wherein applying the second SAO process comprises: obtaining a single group of video units by merging the seventh group of video units and the eighth group of video units; obtaining further values of the set of SAO parameters for the single group of video units by applying an SAO process on reconstructed samples of the single group of video units; determining a third cost for the further values based on the cost function; and in accordance with a determination that the third cost is smaller than the first cost and the second cost, updating the values of the set of SAO parameters for the seventh group of video units and the eighth group of video units with the further values.

Clause 16. The method of any of clauses 1-15, wherein the number of SAO processes applied for the current region is different from the number of SAO processes applied for a further region of the video different from the current region.

Clause 17. The method of any of clauses 1-16, wherein a multi-pass SAO procedure comprising the first SAO process and the second SAO process is terminated if at least one of the following conditions is met: the number of SAO processes applied for the current region is larger than a threshold, a cost of an SAO process is not reduced, or the cost of the SAO process is increased.

Clause 18. The method of any of clauses 1-17, wherein the plurality of video units comprises a group of video units sharing the same values of the set of SAO parameters, and the values of the set of SAO parameters for the group of video units are updated during the second SAO process.

Clause 19. The method of any of clauses 1-18, wherein the plurality of video units comprises a group of video units sharing the same values of the set of SAO parameters, and a video unit neighboring to the group of video units is merged into the group of video units during the second SAO process.

Clause 20. The method of any of clauses 1-19, wherein the plurality of video units comprises a group of video units sharing the same values of the set of SAO parameters, and a further group of video units neighboring to the group of video units is merged into the group of video units during the second SAO process.

Clause 21. The method of any of clauses 1-20, wherein the plurality of video units comprises a group of video units sharing the same values of the set of SAO parameters, and video units in a further group of video units neighboring to the group of video units are merged into the group of video units recursively during the second SAO process.

Clause 22. The method of any of clauses 2-21, wherein the first indication of a video unit in the plurality of video units is updated during the second SAO process.

Clause 23. The method of any of clauses 1-22, wherein an SAO type of a video unit in the plurality of video units is updated during the second SAO process.

Clause 24. The method of any of clauses 1-23, wherein a merge flag of a video unit in the plurality of video units is updated during the second SAO process.

Clause 25. The method of any of clauses 1-24, wherein information regarding whether to enable the SAO at one of the following levels is determined after a multi-pass SAO procedure comprising the first SAO process and the second SAO process is performed: a slice level, a picture level, a tile level, a coding tree unit (CTU) level, a coding tree block (CTB) level, or a region level.

Clause 26. The method of any of clauses 1-24, wherein information regarding whether to enable the SAO at one of the following levels is determined during a multi-pass SAO procedure comprising the first SAO process and the second SAO process: a slice level, a picture level, a tile level, a coding tree unit (CTU) level, a coding tree block (CTB) level, or a region level.

Clause 27. The method of any of clauses 25-26, wherein the SAO is disabled if the multi-pass SAO procedure does not reduce a cost associated with the set of SAO parameters.

Clause 28. The method of any of clauses 25-26, wherein the SAO is disabled if a cost associated with the set of SAO parameters is not reduced in an SAO process of the multi-pass SAO procedure.

Clause 29. The method of any of clauses 25-26, wherein if a cost of slice level SAO is larger than zero, the slice level SAO is disabled.

Clause 30. The method of any of clauses 1-29, wherein an SAO flag for a video unit of the plurality of video units is set to disable temporarily for a context-based adaptive binary arithmetic coding (CABAC) writing of the video unit.

Clause 31. The method of any of clauses 1-30, wherein the current region comprises one of the following: a slice, a picture, a tile, a CTU row, a CTB row, or a region of interest.

Clause 32. The method of clause 31, wherein the region of interest comprises at least one CTU or at least one CTB.

Clause 33. The method of clause 31, wherein the region of interest comprises at least one CTU row or at least one CTB row.

Clause 34. The method of clause 31, wherein the region of interest comprises at least one neighboring CTU or at least one neighboring CTB.

Clause 35. The method of any of clauses 1-34, wherein information regarding whether a multi-pass SAO procedure is performed for a further region of the video is dependent on at least one of the following: a temporal level, a slice type, or a picture order count (POC).

Clause 36. The method of any of clauses 1-34, wherein information regarding whether a multi-pass SAO procedure is performed at one of the following levels is dependent on at least one of a temporal level, a slice type, or a POC: a slice level, a picture level, a tile level, a CTU level, a CTB level, or a region level.

Clause 37. The method of any of clauses 1-35, wherein the set of SAO parameters is a part of all SAO parameters for a video unit of the plurality of video units.

Clause 38. The method of any of clauses 1-37, wherein a multi-pass SAO procedure comprising the first SAO process and the second SAO process is applied to a part of regions in a slice or a picture of the video.

Clause 39. The method of clauses 38, wherein the part of regions comprises a region of interest.

Clause 40. The method of any of clauses 38-29, wherein a single-pass SAO procedure is applied to the rest of regions in the slice or the picture.

Clause 41. The method of any of clauses 1-40, wherein the method is applied to a filtering process different from the SAO.

Clause 42. The method of clause 41, wherein the filtering process comprises at least one of the following: a bilateral filtering, an adaptive loop filter (ALF), or a discrete cosine transform (DCT) domain filtering.

Clause 43. The method of any of clauses 1-42, wherein the conversion includes encoding the current region into the bitstream.

Clause 44. The method of any of clauses 1-42, wherein the conversion includes decoding the current region from the bitstream.

Clause 45. An apparatus for video processing comprising a processor and a non-transitory memory with instructions thereon, wherein the instructions upon execution by the processor, cause the processor to perform a method in accordance with any of clauses 1-44.

Clause 46. A non-transitory computer-readable storage medium storing instructions that cause a processor to perform a method in accordance with any of clauses 1-44.

Clause 47. A non-transitory computer-readable recording medium storing a bitstream of a video which is generated by a method performed by an apparatus for video processing, wherein the method comprises: obtaining values of a set of sample adaptive offset (SAO) parameters for each of a plurality of video units in the current region by applying a first SAO process on reconstructed samples of a current region of the video; applying a second SAO process on the reconstructed samples of the current region based on the values of the set of SAO parameters; and generating the bitstream based on a result of the applying of the second SAO process.

Clause 48. A method for storing a bitstream of a video, comprising: obtaining values of a set of sample adaptive offset (SAO) parameters for each of a plurality of video units in the current region by applying a first SAO process on reconstructed samples of a current region of the video; applying a second SAO process on the reconstructed samples of the current region based on the values of the set of SAO parameters; generating the bitstream based on a result of the applying of the second SAO process; and storing the bitstream in a non-transitory computer-readable recording medium.

### Example Device

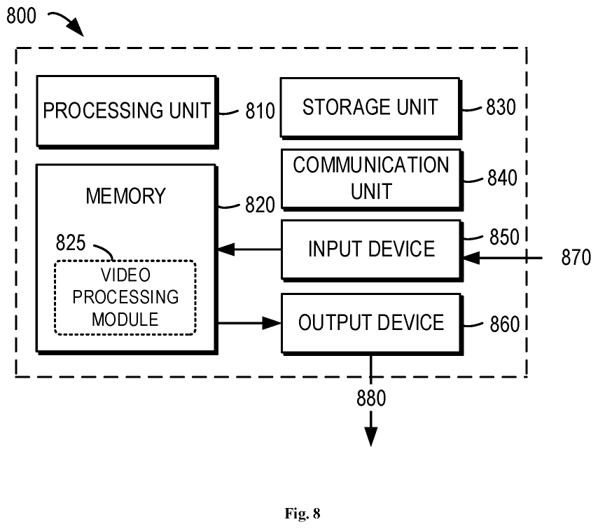

FIG. 8 illustrates a block diagram of a computing device 800 in which various embodiments of the present disclosure can be implemented. The computing device 800 may be implemented as or included in the source device 110 (or the video encoder 114 or 200) or the destination device 120 (or the video decoder 124 or 300).

It would be appreciated that the computing device 800 shown in FIG. 8 is merely for purpose of illustration, without suggesting any limitation to the functions and scopes of the embodiments of the present disclosure in any manner.

As shown in FIG. 8, the computing device 800 includes a general-purpose computing device 800. The computing device 800 may at least comprise one or more processors or processing units 810, a memory 820, a storage unit 830, one or more communication units 840, one or more input devices 850, and one or more output devices 860.

In some embodiments, the computing device 800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 800 can support any type of interface to a user (such as “wearable” circuitry and the like).

The processing unit 810 may be a physical or virtual processor and can implement various processes based on programs stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem and the like) enabling the computing device 800 to communicate with one or more other computing devices, if required. Such communication can be performed via input/output (I/O) interfaces (not shown).

In some embodiments, instead of being integrated in a single device, some or all components of the computing device 800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 800 may be used to implement video encoding/decoding in embodiments of the present disclosure. The memory 820 may include one or more video coding modules 825 having one or more program instructions. These modules are accessible and executable by the processing unit 810 to perform the functionalities of the various embodiments described herein.

In the example embodiments of performing video encoding, the input device 850 may receive video data as an input 870 to be encoded. The video data may be processed, for example, by the video coding module 825, to generate an encoded bitstream. The encoded bitstream may be provided via the output device 860 as an output 880.

In the example embodiments of performing video decoding, the input device 850 may receive an encoded bitstream as the input 870. The encoded bitstream may be processed, for example, by the video coding module 825, to generate decoded video data. The decoded video data may be provided via the output device 860 as the output 880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
obtaining, for a conversion between a current region of a video and a bitstream of the video, values of a set of sample adaptive offset (SAO) parameters for each of a plurality of video units in the current region by applying a first SAO process on reconstructed samples of the current region;
applying a second SAO process on the reconstructed samples of the current region based on the values of the set of SAO parameters; and
performing the conversion based on a result of the applying of the second SAO process.

2. The method of claim 1, wherein the set of SAO parameters comprises at least one of the following: a first indication indicating whether SAO is enabled or not, an SAO type, or an SAO offset, or
wherein a value of at least one SAO parameter in the set of SAO parameters for one of the plurality of video units is modified during the second SAO process, or
wherein the plurality of video units comprises a first group of video units sharing the same values of the set of SAO parameters, and values of the set of SAO parameters for the first group of video units are modified during the second SAO process, or
wherein the plurality of video units comprises a second group of video units sharing the same values of the set of SAO parameters and a third group of video units sharing the same values of the set of SAO parameters, the second group of video units and the third group of video units are merged into a single group during the second SAO process, or
wherein a first video unit in the plurality of video units is comprised in a fourth group of video units sharing the same values of the set of SAO parameters during the first SAO process, and the first video unit is comprised in a fifth group of video units sharing the same values of the set of SAO parameters during the second SAO process, and the fifth group is different from the fourth group.

3. The method of claim 1, wherein the plurality of video units comprises a sixth group of video units sharing the same values of the set of SAO parameters, and values of the set of SAO parameters for the sixth group of video units are determined based on more than one video units in the sixth group of video units during the second SAO process.

4. The method of claim 3, wherein the set of SAO parameters comprises at least one of: an SAO type of a luma component, an SAO offset of a luma component, an SAO type of a chroma component, or an SAO offset of a chroma component, or
wherein the more than one video units comprise all video units in the sixth group of video units.

5. The method of claim 1, wherein whether to modify the values of the set of SAO parameters during the second SAO process is determined based on a cost function associated with the set of SAO parameters.

6. The method of claim 5, wherein the cost function is dependent on at least one of the following: a distortion reduced by an SAO process with values of set of SAO parameters, or a rate for coding values of the set of SAO parameters, or
wherein the plurality of video units comprises a seventh group of video units sharing the same values of the set of SAO parameters, and a first cost is determined for the values of the SAO parameters for the seventh group of video units based on the cost function.

7. The method of claim 6, wherein the cost function is:
$$C = - D + lambda \times R$$
where C represents a cost, D represents the distortion, R represents the rate, and lambda represents a predetermined parameter, or
wherein applying the second SAO process comprises: obtaining further values of the set of SAO parameters for the seventh group of video units by applying an SAO process on reconstructed samples of the seventh group of video units; determining a second cost for the further values based on the cost function; and in accordance with a determination that the second cost is smaller than the first cost, updating the values of the set of SAO parameters with the further values, or
wherein the plurality of video units comprises an eighth group of video units sharing the same values of the set of SAO parameters, a second cost is determined for the values of the SAO parameters for the eighth group of video units based on the cost function, and wherein applying the second SAO process comprises: obtaining a single group of video units by merging the seventh group of video units and the eighth group of video units; obtaining further values of the set of SAO parameters for the single group of video units by applying an SAO process on reconstructed samples of the single group of video units; determining a third cost for the further values based on the cost function; and in accordance with a determination that the third cost is smaller than the first cost and the second cost, updating the values of the set of SAO parameters for the seventh group of video units and the eighth group of video units with the further values.

8. The method of claim 1, wherein the number of SAO processes applied for the current region is different from the number of SAO processes applied for a further region of the video different from the current region, or
wherein a multi-pass SAO procedure comprising the first SAO process and the second SAO process is terminated if at least one of the following conditions is met: the number of SAO processes applied for the current region is larger than a threshold, a cost of an SAO process is not reduced, or the cost of the SAO process is increased, or
wherein the plurality of video units comprises a group of video units sharing the same values of the set of SAO parameters, and the values of the set of SAO parameters for the group of video units are updated during the second SAO process, or
wherein the plurality of video units comprises a group of video units sharing the same values of the set of SAO parameters, and a video unit neighboring to the group of video units is merged into the group of video units during the second SAO process, or
wherein the plurality of video units comprises a group of video units sharing the same values of the set of SAO parameters, and a further group of video units neighboring to the group of video units is merged into the group of video units during the second SAO process, or
wherein the plurality of video units comprises a group of video units sharing the same values of the set of SAO parameters, and video units in a further group of video units neighboring to the group of video units are merged into the group of video units recursively during the second SAO process.

9. The method of claim 2, wherein the first indication of a video unit in the plurality of video units is updated during the second SAO process.

10. The method of claim 1, wherein an SAO type of a video unit in the plurality of video units is updated during the second SAO process, or
wherein a merge flag of a video unit in the plurality of video units is updated during the second SAO process.

11. The method of claim 1, wherein information regarding whether to enable the SAO at one of the following levels is determined after a multi-pass SAO procedure comprising the first SAO process and the second SAO process is performed: a slice level, a picture level, a tile level, a coding tree unit (CTU) level, a coding tree block (CTB) level, or a region level, or
wherein information regarding whether to enable the SAO at one of the following levels is determined during a multi-pass SAO procedure comprising the first SAO process and the second SAO process: a slice level, a picture level, a tile level, a coding tree unit (CTU) level, a coding tree block (CTB) level, or a region level.

12. The method of claim 11, wherein the SAO is disabled if the multi-pass SAO procedure does not reduce a cost associated with the set of SAO parameters, or
wherein the SAO is disabled if a cost associated with the set of SAO parameters is not reduced in an SAO process of the multi-pass SAO procedure, or
wherein if a cost of slice level SAO is larger than zero, the slice level SAO is disabled.

13. The method of claim 1, wherein an SAO flag for a video unit of the plurality of video units is set to disable temporarily for a context-based adaptive binary arithmetic coding (CABAC) writing of the video unit, or
wherein the current region comprises one of the following: a slice, a picture, a tile, a CTU row, a CTB row, or a region of interest.

14. The method of claim 13, wherein the region of interest comprises at least one CTU or at least one CTB, or
wherein the region of interest comprises at least one CTU row or at least one CTB row, or
wherein the region of interest comprises at least one neighboring CTU or at least one neighboring CTB.

15. The method of claim 1, wherein information regarding whether a multi-pass SAO procedure is performed for a further region of the video is dependent on at least one of the following: a temporal level, a slice type, or a picture order count (POC), or
wherein information regarding whether a multi-pass SAO procedure is performed at one of the following levels is dependent on at least one of a temporal level, a slice type, or a POC: a slice level, a picture level, a tile level, a CTU level, a CTB level, or a region level, or
wherein the set of SAO parameters is a part of all SAO parameters for a video unit of the plurality of video units, or
wherein a multi-pass SAO procedure comprising the first SAO process and the second SAO process is applied to a part of regions in a slice or a picture of the video, or
wherein the method is applied to a filtering process different from the SAO.

16. The method of claim 15, wherein the part of regions comprises a region of interest, or
wherein a single-pass SAO procedure is applied to the rest of regions in the slice or the picture, or
wherein the filtering process comprises at least one of the following: a bilateral filtering, an adaptive loop filter (ALF), or a discrete cosine transform (DCT) domain filtering.

17. The method of claim 1, wherein the conversion includes encoding the current region into the bitstream, or
wherein the conversion includes decoding the current region from the bitstream.

18. An apparatus for video processing comprising a processor and a non-transitory memory with instructions thereon, wherein the instructions upon execution by the processor, cause the processor to perform acts comprising:
obtaining, for a conversion between a current region of a video and a bitstream of the video, values of a set of sample adaptive offset (SAO) parameters for each of a plurality of video units in the current region by applying a first SAO process on reconstructed samples of the current region;
applying a second SAO process on the reconstructed samples of the current region based on the values of the set of SAO parameters; and
performing the conversion based on a result of the applying of the second SAO process.

19. A non-transitory computer-readable storage medium storing instructions that cause a processor to perform acts comprising:
obtaining, for a conversion between a current region of a video and a bitstream of the video, values of a set of sample adaptive offset (SAO) parameters for each of a plurality of video units in the current region by applying a first SAO process on reconstructed samples of the current region;
applying a second SAO process on the reconstructed samples of the current region based on the values of the set of SAO parameters; and
performing the conversion based on a result of the applying of the second SAO process.

20. A non-transitory computer-readable recording medium storing a bitstream of a video which is generated by a method performed by an apparatus for video processing, wherein the method comprises:
obtaining values of a set of sample adaptive offset (SAO) parameters for each of a plurality of video units in the current region by applying a first SAO process on reconstructed samples of a current region of the video;
applying a second SAO process on the reconstructed samples of the current region based on the values of the set of SAO parameters; and
generating the bitstream based on a result of the applying of the second SAO process.
